(19) United States
(12) Patent Application Publication
(10) Pub. No.: US 2008/0126521 A1
(43) Pub. Date: May 29, 2008

(54) Network device management system and method

(76) Inventor: David H. Hanes, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/524,586

(22) Filed: Sep. 21, 2006

(51) Int. Cl. G06F 15/177

(52) U.S. Cl. 709/221

(57) ABSTRACT

A network device management system comprises a network-attachable device having logic for automatically renaming, using a network basic input/output system (NetBIOS) protocol, the device in response to a network name collision associated with the device on an attached network.

### BACKGROUND OF THE INVENTION

Local area networks are used in a variety of types of computing environments (e.g., small offices and/or homes). Various types of devices may be attached to the network such as, but not limited to, a printer, one or more personal computers, a docking station, a router, and a storage device. Each device attached to the network needs a unique network name associated with it to distinguish it from another device on the network. However, network name collisions routinely occur (e.g., where two or more devices attempt to use the same network name), especially when several of the same types of devices are attached to the network, thereby requiring a tedious and time-consuming process of manually renaming certain devices.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a network device management system in accordance with the present invention; and

FIG. 2 is a flow diagram illustrating an embodiment of network device management method in accordance with the present invention.

### DETAILED DESCRIPTION OF THE DRAWINGS

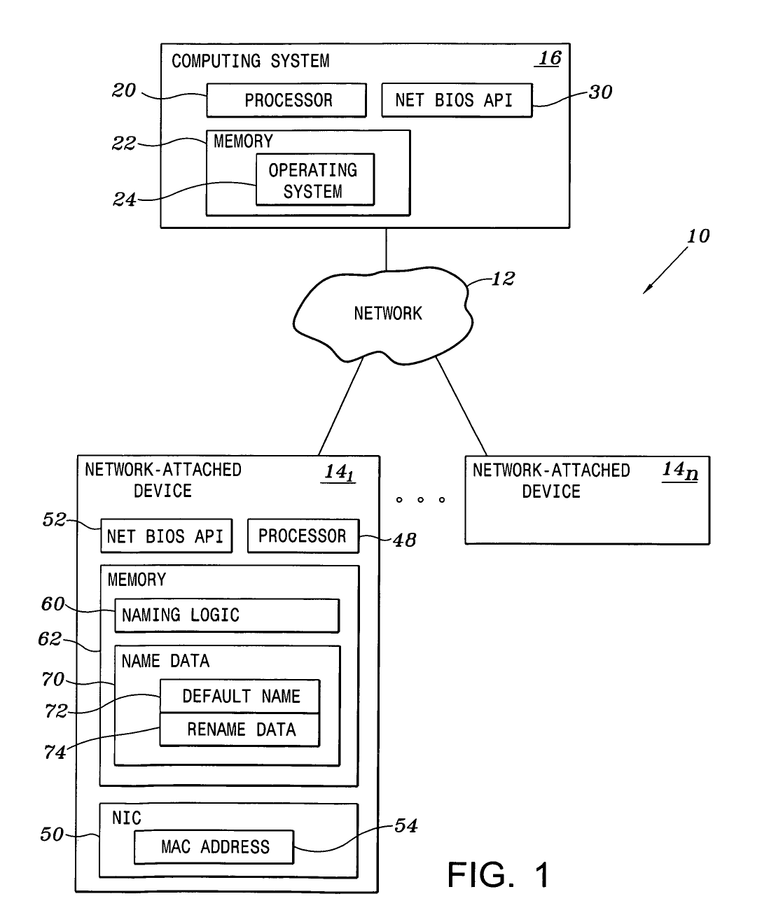

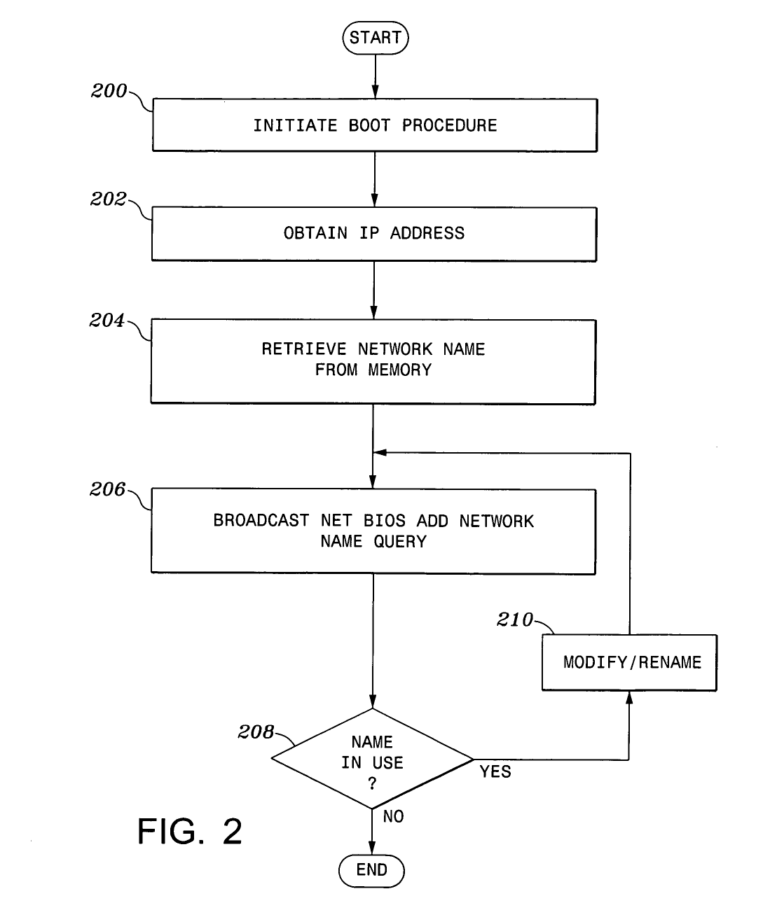

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of a network device management system 10 in accordance with the present invention. In the embodiment illustrated in FIG. 1, system 10 comprises a local area network 12 for communicatively coupling network-attachable devices 14₁-14ₙ to a host computing system 16. Network-attachable device(s) 14 may comprise any type of device configured to be attached to network 12 such as, but not limited to, a printer, a docking station, a personal computer, router, facsimile machine, or a storage device. Network-attached device(s) 14 may be communicatively coupled to network 12 via a wired or wireless connection. Further, host computing system 16 may be coupled to network 12 via a wired or wireless connection.

In the embodiment illustrated in FIG. 1, host computing system 16 comprises a processor 20 and a memory 22 having an operating system 24 stored therein and executable by processor 20. In FIG. 1, host computing system 16 also comprises a network basic input/output system (NetBIOS) application programming interface (API) 30 for communicating via a NetBIOS protocol between host computing system 16 and network-attached devices 14.

For ease of understanding, the embodiment of the present invention described below is made with reference to device 14₁; however, it should be understood that other devices attachable to network 12 may be similarly or differently configured. In the embodiment illustrated in FIG. 1, network-attached device 14₁ comprises a processor 48, a network interface card (NIC) 50, a NetBIOS API 52 for communicating over network 12 via the NetBIOS protocol, and a memory 62. NIC 50 is used to physically interface network-attached device 14₁ to network 12 and comprises a media access control (MAC) address 54 for uniquely identifying network-attached device 14₁ on network 12 (e.g., at the data link layer of the open systems interconnection (OSI) model). It should be understood that an Internet protocol (IP) address for 14₁ on network 12 is mapped to MAC address 54.

In the embodiment illustrated in FIG. 1, memory 62 comprises naming logic 60. Naming logic 60 may comprise software, hardware, firmware, or a combination thereof, and may comprise a set of executable instructions (e.g., executable by processor 48). In the embodiment illustrated in FIG. 1, naming logic 60 is used to automatically rename or change/modify a network name of network-attached device 14₁ in response to a network name collision between a network name of network-attached device 14₁ and another device attached to network 12 (i.e., another device on network 12 using the same network name on network 12 as the network name intended to be used by network-attached device 14₁ on network 12).

In the embodiment illustrated in FIG. 1, memory 62 also comprises network name data 70 having information associated with a network name of network-attached device 14₁. For example, in the embodiment illustrated in FIG. 1, network name data 70 comprises a default name 72 and rename data 74. Default name 72 comprises a network name preset and/or prestored for network-attached device 14₁. For example, a network name for network-attached device 14 is generally a name easily remembered and/or located by a user (e.g., via a drop-down menu, tree listing or other type of interface) to facilitate locating, selecting and/or communicating with device 14₁. Rename data 74 comprises information associated with automatically renaming the network name of device 14₁ in response to detecting a network name collision on network 12. For example, in some embodiments of the present invention, rename data 74 comprises one or more alternate network names for device 14₁ and/or instructions for modifying default name 72 to another/new network name. In some embodiments of the present invention, rename data 74 comprises one or more prefixes and/or suffixes that may be appended to default name 72 to alleviate a network name collision while retaining at least a portion of default name 72 to facilitate identification of device 14₁. However, it should be understood that rename data 74 may comprise other types of information and/or methods for renaming the network name of device 14₁ (e.g., inserting a predetermined character or set of characters into the body of default name 72, reversing the order of the characters of default name 72, concatenating default name 72 in a predetermined method, etc.).

In operation, in response to attachment of device 14₁ to network 12, network-attached device 14₁ communicates with host computing system 16 to provide MAC address 54 and obtain an IP address for device 14₁ to facilitate communications therewith across network 12. However, it should be understood that an IP address for device 14₁ may be otherwise provided and/or configured (e.g., the IP address for device 14₁ may comprise a static IP address manually configured or set for device 14₁ and/or the IP address for device 14₁ may be provided by another device on network 12, such as a router). After an IP address has been assigned and/or associated with network-attached device 14₁, logic 60 causes the retrieval of default name 72 from memory 62 and broadcasts default name 72 onto network 12 using the NetBIOS protocol using NetBIOS API 52 in cooperation with NIC 50. If another device attached to network 12 does not respond as having the same network name as default name 72, network-attached device 14, uses default name 72 as its network name. However, if another device attached to network 12 responds with an error or other type of signal indicating a network name collision (e.g., another device attached to network 12 using a network name matching default name 72), naming logic 60 automatically renames and/or modifies the network name of device 14₁ from default name 72 to another network name to resolve the network name collision. For example, in some embodiments of the present invention, naming logic 60 accesses and/or causes to be accessed rename data 74 to identify another/new name and/or a modification to make to default name 72. Using the renamed network name for device 14₁, naming logic 60 causes to be broadcast the renamed/new network name for device 14₁ to network 12 to determine whether another network name collision exists. If another network name collision exists, the above procedure may repeated until a network-name collision no longer exists or until the renaming procedure has been attempted a predetermined number of times.

In some embodiments of the present invention, network-attached device 14₁ is configured to perform a network name renaming/modification procedure in response to a network name clash with a subsequently attached device to network 12. For example, in some embodiments of the present invention, if a subsequently attached device to network 12 broadcasts a desired network name that clashes with the network name adopted or currently used by device 14₁ (e.g., clashing with either default name 72 or a previously modified/renamed network name of device 14₁), naming logic 60 automatically renames and/or modifies the network name of device 14₁ (e.g., from default name 72 or a previously renamed/modified network name of device 14₁) to another network name to resolve the network name collision and automatically causes to be broadcast a renamed/new network name for device 14₁ to network 12. Thus, some embodiments of the present invention resolve network name collisions resulting from subsequently added devices onto network 12.

Preferably, if device 14₁ is removed from network 12 and attached to a different network or re-attached to network 12 at a later time, device 14₁ is configured to attempt to use default name 72 on network regardless of whether device 14₁ was previously using default name 72 or a renamed network name on network 12 (thus, performing a rename/modification procedure if a network name clash is present). However, it should be understood that in some embodiments of the present invention, if the network name of device 14₁ was renamed/modified, device 14₁ is configured to attempt to use the renamed/modified network name upon its attachment to another network or re-attachment to network 12. In this example, if there is a network name clash, device 14₁ may be configured to attempt to use default name 72 and/or further use a further modified network name.

FIG. 2 is a flow diagram illustrating an embodiment of a network device management method in accordance with the present invention. In FIG. 2, the method begins at block 200, where network-attached device 14₁ initiates a boot procedure. At block 202, network-attached device 14₁ communicates with host computing system 16 and obtains an IP address for device 14₁. As discussed above, it should be understood that an IP address for device 14₁ may be otherwise provided and/or configured (e.g., the IP address for device 14₁ may comprise a static IP address manually configured or set for device 14₁ and/or the IP address for device 14₁ may be provided by another device on network 12, such as a router). At block 204, naming logic 60 causes retrieval of default name 72 from memory 62. At block 206, naming logic 60 cooperates with NetBIOS API 52 and NIC 50 to broadcast default name 72 to network 12 using the NetBIOS protocol to determine whether a network name collision exists for default name 72. At decisional block 208, a determination is made whether default name 72 is being used by another device attached to network 12. If another device is not using default name 72 as a network name, the method ends and network-attached device 14₁ uses default name 72 as its network name. If at decisional block 208 it is determined that a network name collision exists such that another device coupled to network 12 is using default name 72 as its network name, the method proceeds to block 210, where naming logic 60 is used to modify and/or rename the network name for device 14₁ (e.g., using rename data 74). The method proceeds to block 206, where the renamed/new network name for device 14₁ is broadcast to network 12 to determine whether a network name collision exists for the renamed/new network name of device 14₁. As discussed above, the above method is generally repeated until any network name collision no longer exists for device 14₁ or for some predetermined number of attempts to resolve the network name collision.

Thus, embodiments of the present invention automatically resolve a network name collision on a network using the NetBIOS protocol that is driven and/or performed by the device being attached to the network (i.e., the device whose network name is already in use on the network). Thus, embodiments of the present invention substantially prevent or eliminate a user attaching a device 14 to a network from manually configuring the device in the event of a network name collision on the network.

It should be understood that in the described method, certain functions may be omitted, accomplished in a sequence different from that depicted in FIG. 2, or performed simultaneously. Also, it should be understood that the method depicted in FIG. 2 may be altered to encompass any of the other features or aspects of the invention as described elsewhere in the specification. Further, embodiments of the present invention may be implemented in software and can be adapted to run on different platforms and operating systems. In particular, functions implemented by naming logic 60, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium.

What is claimed is:

1. A network device management system, comprising:
a network-attachable device having logic for automatically renaming, using a network basic input/output system (NetBIOS) protocol, the device in response to a network name collision associated with the device on an attached network.

2. The system of claim 1, wherein the logic is configured to automatically add a suffix to a default network name of the device in response to detecting the network name collision.

3. The system of claim 1, wherein the logic is configured to automatically broadcast to the attached network a network name different from a default network name of the device in response to detecting the network name collision.

4. The system of claim 1, wherein the logic is configured to retrieve a default network name from a memory of the device.

5. The system of claim 1, wherein the logic is configured to automatically rename the device to a network name different than a default network name of the device.

6. The system of claim 1, wherein the logic is configured to automatically add a prefix to a default network name of the device in response to detecting the network name collision.

7. A network device management system, comprising:
means for automatically renaming, using a network basic input/output system (NetBIOS) protocol, a network-attachable device means in response to a network name collision associated with the device means on an attached network means.

8. The system of claim 7, wherein the renaming means comprises means for renaming the device means to a network name different than a default network name of the device means.

9. The system of claim 7, wherein the renaming means comprises means for retrieving a default network name of the device means from a memory means of the device means.

10. The system of claim 7, wherein the renaming means comprises means for broadcasting to the attached network means a network name different from a default network name of the device means in response to detecting the network name collision.

11. The system of claim 7, wherein the renaming means comprises means for automatically adding a suffix to a default network name of the device means in response to detecting the network name collision.

12. A network device management method, comprising:
automatically renaming, using a network basic input/output system (NetBIOS) protocol, a network-attachable device in response to a network name collision associated with the device on an attached network.

13. The method of claim 12, further comprising renaming the device to a network name different than a default network name of the device.

14. The method of claim 12, further comprising retrieving a default network name of the device from a memory of the device.

15. The method of claim 12, further comprising broadcasting to the attached network a network name different from a default network name of the device in response to detecting the network name collision.

16. The method of claim 12, further comprising automatically adding a suffix to a default network name of the device in response to detecting the network name collision.

17. The method of claim 12, further comprising automatically adding a prefix to a default network name of the device in response to detecting the network name collision.

18. A computer-readable medium having stored thereon an instruction set to be executed, the instruction set, when executed by a processor, causes the processor to:
automatically rename, using a network basic input/output system (NetBIOS) protocol, a network-attachable device in response to a network name collision associated with the device on an attached network.

19. The computer-readable medium of claim 18, wherein the instruction set, when executed by the processor, causes the processor to rename the device to a network name different than a default network name of the device.

20. The computer-readable medium of claim 18, wherein the instruction set, when executed by the processor, causes the processor to broadcast to the attached network a network name different from a default network name of the device in response to detecting the network name collision.
